(19) United States
(12) Patent Application Publication
(10) Pub. No.: US 2016/0045383 A1
(43) Pub. Date: Feb. 18, 2016

(54) Rehabilitation Bed

(71) Applicant: Mike Soo, Tainan (TW)

(72) Inventor: Mike Soo, Tainan (TW)

(21) Appl. No.: 14/460,419

(22) Filed: Aug. 15, 2014

(51) Int. Cl. A61G 7/018; A63B 21/00; A61H 7/00; A61G 7/075

(52) U.S. Cl. CPC A61G 7/018; A61G 7/0755; A63B 21/00047; A61H 7/007

(57) ABSTRACT

A rehabilitation bed includes a frame assembly, a mattress leg section, a mattress middle section, and a mattress back section. A pedaling portion is mounted between the mattress leg section and the frame assembly. The mattress leg section includes two legrests that can be moved away from each other to permit a patient to use the pedaling portion for rehabilitation of the legs of the patient. The mattress middle section can be moved to an upper position to elevate the body of the patient, permitting the patient to freely move the arms and legs for rehabilitation. The mattress back section can be moved to be an inclined state permitting the patient to be in a sitting position. An auxiliary exerciser can optionally be mounted to an outer side of the frame assembly, permitting weight training of the arms of the patient.

### BACKGROUND OF THE INVENTION

The present invention relates to a rehabilitation bed and, more particularly, to a sickbed combined with various exercise devices for rehabilitation, allowing a patient lying in the sickbed to proceed with various rehabilitation exercises.

A human body may have to lie in a sickbed for a long period of time due to diseases or injuries. The muscles of the human body could waste away due to non movement of the arms and legs. To avoid this problem, a rehabilitation bed currently available in the market includes a hand rehabilitation device. Specifically, two supports are provided on two sides of the bed, and a barbell is placed on the supports, permitting a user to exercise the muscles by lifting the barbell with hands. However, such a rehabilitation bed only provides weight training for arms without any training for legs. Furthermore, the mattress of this rehabilitation bed can not be adjusted such that the patient can only lie on the back or stomach.

Another rehabilitation bed available in the market can forcibly move the arms and legs of a patient lying in the bed. Specifically, a motor is mounted to a center of a tail portion of the bed to drive a crank arm connected to two pedals. An upright post is fixed to a head portion of the bed. A transverse rod is mounted to a top of the upright post. A pulley is mounted to each of two ends of the transverse rod. Two cables are provided, with each cable including an end connected to one of the two pedals and wound around one of the pulleys, and with the other end of each cable connected to a handle. The feet of the patient step on the two pedals, and the hands of the patient grip the handles. The motor is activated to drive the pedals to rotate, and the cables are driven to pull the hands in addition to movement of the feet on the pedals, achieving a compulsory rehabilitation. The motor is directly mounted on the mattress of the rehabilitation bed and, thus, occupies a portion of the mattress, which is disadvantageous to the patient lying in the bed over a long period of time. In another approach, the motor is mounted only when rehabilitation of the arms and legs is required, yet it is inconvenient to use.

Thus, a need exists for a novel rehabilitation bed that mitigates and/or obviates the disadvantages of conventional rehabilitation beds.

### BRIEF SUMMARY OF THE INVENTION

The present invention solves this need and other problems in the field of ease of use of rehabilitation beds by providing a rehabilitation bed including a frame assembly having a first fence, a second fence spaced from the first fence along a first axis, and a chassis extending between the first and second fences. The chassis includes a first portion adjacent to the first fence, a second portion adjacent to the second fence, and an intermediate portion between the first and second portions. Two tracks are respectively mounted to two sides of the first portion of the chassis. Each of the two tracks includes first and second ends spaced from each other along a second axis perpendicular to the first axis and a sliding channel extending from the second end towards the first end of the track. Two sliding seats are respectively and slideably coupled to the two sliding tracks. Each of the two sliding seats includes a transverse beam slideably received in the sliding channel of one of the two sliding tracks. Each of the two sliding seats further includes a vertical beam extending from the transverse beam and located outside of the sliding channel. Two bottom boards are respectively mounted to the vertical beams of the two sliding seats. Two legrests are respectively fixed to the two bottom boards. Two first cylinders are provided. Each of the two first cylinders includes a telescopic piston rod coupled to the one of the two sliding seats. Each of the two first cylinders includes an end connected to one of the two tracks. Each of the two first cylinders is operable to push one of the two sliding seats to move between a closed position and a second position. The two sliding seats in the first position are close to each other and are located adjacent to the first portion of the chassis. The two sliding seats in the second position are spaced from each other and have a spacing therebetween larger than a spacing between the two sliding seats in the first position. A first power supply is fixed to the chassis and is connected to each of the two first cylinders to provide power to the two first cylinders. A pedaling portion is mounted to the first portion of the frame assembly and is located between the two sliding seats and the two bottom boards. The pedaling portion includes an upright support fixed to the first portion of the frame assembly and a flywheel rotatably mounted to the upright support. Two pedals are rotatably mounted to the upright support and are located on two sides of the upright support. The two pedals are operably connected to the flywheel. A mattress middle section is mounted to the intermediate portion of the chassis and includes a middle mat. A mattress back section is mounted to the second portion of the chassis and includes a back mat.

When the two sliding seats are in the closed position, the two legrests are close to each other to cover the pedaling portion, not permitting use of the pedaling portion.

When the two sliding seats are in the open position, the two legrests are spaced from each other to reveal the pedaling portion, permitting use of the pedaling portion.

In an embodiment, each of the two bottom boards includes first and second sides spaced from each other along the second axis. A first pivotal block is mounted to a bottom side of each of the two bottom boards and located adjacent to the first side of the bottom board. The first pivotal block defines a first pivot axis parallel to the first axis. A second pivotal block is mounted to an intermediate portion of the bottom side of each of the two bottom boards. The first pivotal block on each of the two bottom boards is pivotably mounted to the vertical beam. The rehabilitation bed further includes two second cylinders connected to the first power supply. Each of the two second cylinders is connected to one of the two sliding seats and includes a telescopic piston rod having an end pivotably connected to the second pivotal block of one of the two bottom boards. Each of the two second cylinders is operable to control one of the two bottom boards to pivot between a horizontal position and a tilted position about the first pivot axis defined by the first pivotal block. When the two sliding seats are in the closed position, the two legrests are in the horizontal position. When the two sliding seats are in the open position, each of the two second cylinders are operable to control one of the two legrests to pivot to the tilted position.

The mattress back section can include a massage device pivotably mounted to the second portion of the chassis. The back mat mounted to a side of the massage device. A third cylinder includes a telescopic piston rod connected to the massage device. The telescopic piston rod includes an end pivotably connected to the chassis. The third cylinder is operable to push the massage device to pivot between a first position and a second position about a second pivot axis parallel to the second axis. A second power supply is fixed to the chassis and is connected to the third cylinder to provide power to the third cylinder. When the massage device is in the first position, the back mat is parallel to the middle mat. When the massage device is not in the first position, the back mat is at an obtuse angle to the middle mat.

The mattress back section can further include a fixing seat fixed to the second portion of the chassis. The fixing seat includes two first pivotal ears spaced from each other along the second axis and defining the second pivot axis. Two pivotal blocks are mounted to the fixing seat and are spaced from each other along the second axis. Two track rods are fixed to a bottom side of the massage device. Two sliding grooves are defined in two mutually facing sides respectively of the two track rods. Two first rods are provided. Each of the two first rods includes an end slideably received in one of the two sliding grooves. Each of the two first rods includes an intermediate portion pivotably connected to one of the two pivotal blocks. A fixing rod is fixed to the other end of each of the two first rods. The fixing rod is pivotably connected to a distal end of the telescopic piston rod of the third cylinder. Two second rods are provided. Each of the two second rods includes an intermediate portion pivotably connected to one of the two pivotal blocks. Each of the two second rods includes an end pivotably connected to one of the two track rods. Each of the two second rods is cross-hinged to one of the two first rods. Each of the two second rods further includes another end pivotably connected to one of the first pivotal ears, fixing an inclination angle of each of the two second rods.

The massage device can include a seat fixed to the two track rods. The seat includes an installation space defined in a side thereof. A first motor is mounted to the seat. A screw rod is rotatably mounted in the installation space of the seat and extends along the first axis. The screw rod includes an end coupled to the motor. A movable block is threadedly coupled to the screw rod. The motor is operable to rotate the screw rod, moving the movable block in the installation space. A plurality of massaging wheels is mounted to the movable block and abuts the back mat.

The mattress middle section can further include a gear reduction mechanism mounted to the intermediate portion of the chassis, a second motor including a rotating shaft coupled to the gear reduction mechanism, and a screw coupled to the gear reduction mechanism and extending along the third axis. The middle mat is fixed to the screw. The second motor is operable to move the screw along the third axis, moving the middle mat between an upper position not aligned with and higher than the two legrests along the third axis and a lower position aligned with the two legrests.

The rehabilitation bed can further include an outer support fixed to the frame assembly. The outer support includes an upper beam above the frame assembly and a lower beam fixed to the second fence and located below the back mat. Two guiding rods are fixed to the lower beam and are spaced from each other along the second axis. A plurality of weight blocks is slideably mounted around the two guiding rods. Two first pulleys are rotatably mounted to the upper beam. A cable includes a first end coupled to the plurality of weight blocks and a second end wound around the two first pulleys. A handle is coupled to the second end of the cable. A support is fixed between the upper beam and the first fence. If the handle is pulled, the plurality of weight blocks is moved along the two guiding rods.

The rehabilitation bed can further include a solar panel fixed to the upper beam and a cell mounted to the lower beam and electrically connected to the solar panel.

The rehabilitation bed can further include two protective bars spaced from each other along the second axis and mounted between the first and second fences. A table is detachably mounted to the two protective bars. A monitor is mounted to the first fence. An arm is pivotably mounted to the second fence. A controller is mounted to the arm and is electrically connected to the massage device, the first and second power supplies, and the first and second motors.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a rehabilitation bed according to the present invention.

FIG. 2 is a partial, exploded, perspective view of the rehabilitation bed of FIG. 1.

FIG. 3 is another partial, exploded, perspective view of the rehabilitation bed FIG. 1.

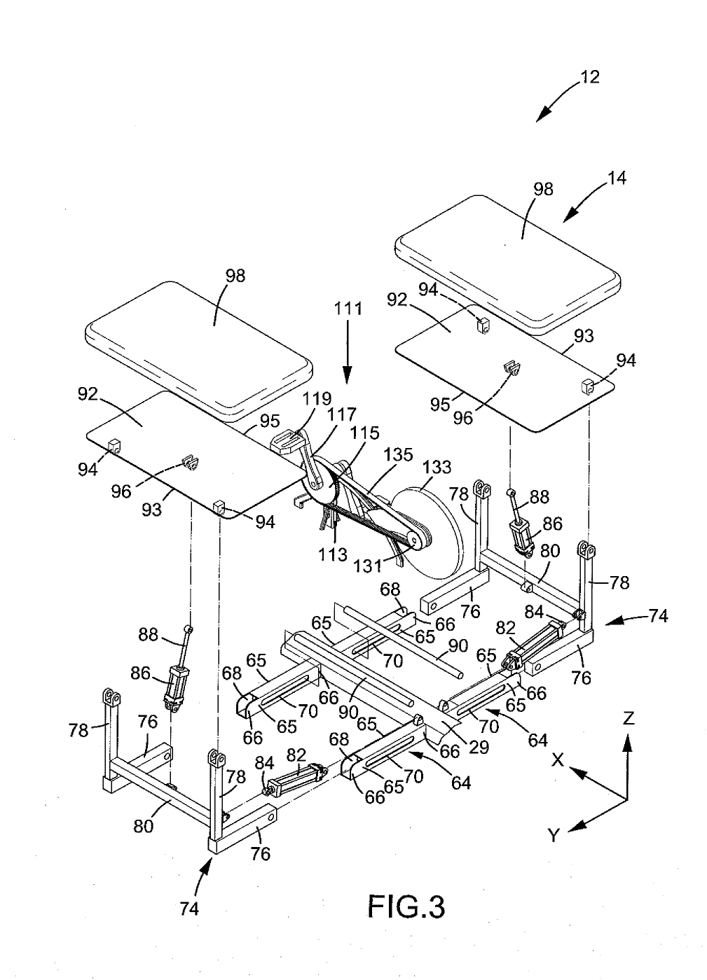

FIG. 4 is an exploded, perspective view of a middle section of a mattress unit of the rehabilitation bed of FIG. 1.

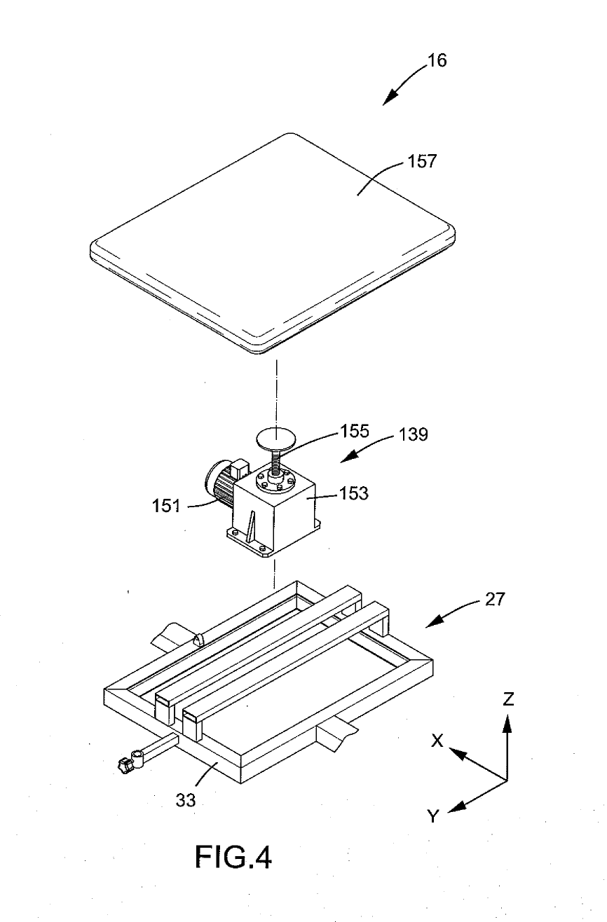

FIG. 5 is an exploded, perspective view of a back section of the mattress unit of the rehabilitation bed of FIG. 1.

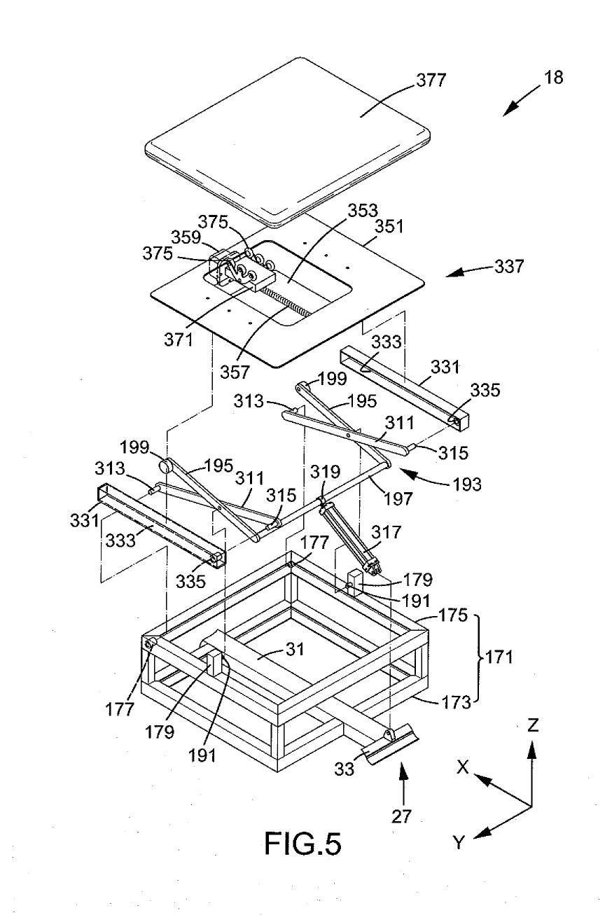

FIG. 6 is a partial, perspective view of the rehabilitation bed of FIG. 1.

FIG. 7 is a side elevational view of the rehabilitation bed of FIG. 6.

FIG. 8 is a cross sectional view taken along section line 8-8 of FIG. 6.

FIG. 9 is a cross sectional view taken along section line 9-9 of FIG. 6.

FIG. 10 is a view similar to FIG. 8, with two sliding seats in an open position spaced from each other.

FIG. 11 is a view similar to FIG. 10, with the two sliding seats in the open position and with two legrests pivoted to a tilted position.

FIG. 12 is a rear view of the rehabilitation bed of FIG. 1, with the two sliding seats in the open position and with the two legrests pivoted to the tilted position.

FIG. 13 is an exploded, perspective view of a portion of the rehabilitation bed of FIG. 1, illustrating an auxiliary exerciser and a solar energy storage device.

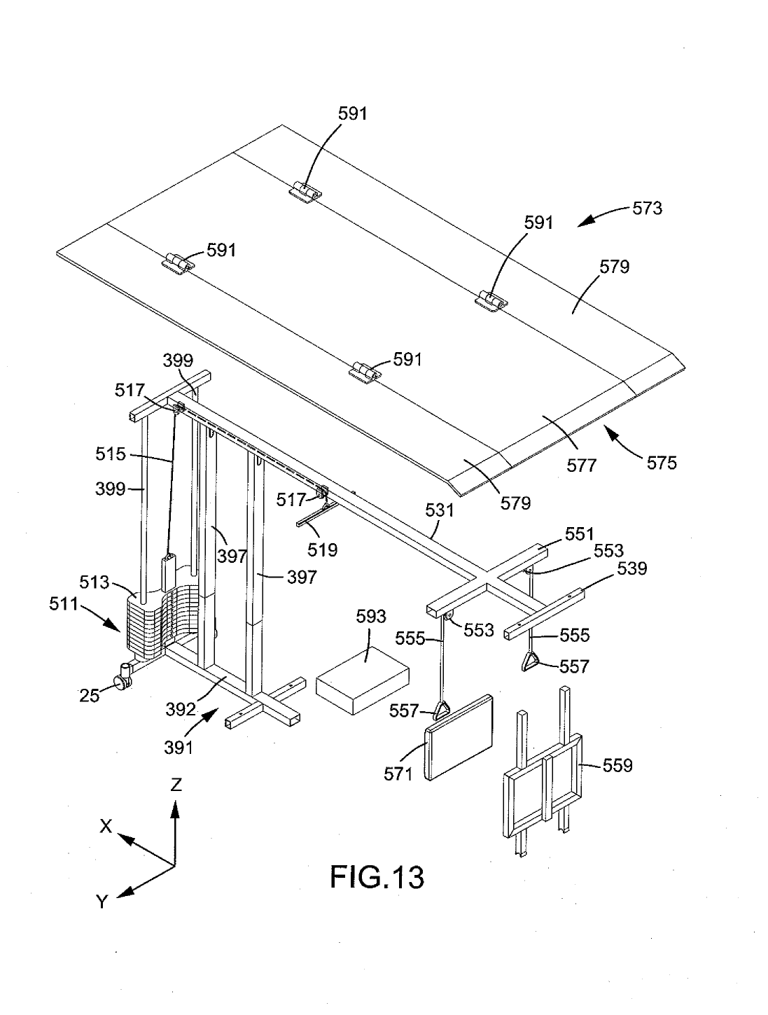

FIG. 14 is a perspective view of the portion of the rehabilitation bed of FIG. 13.

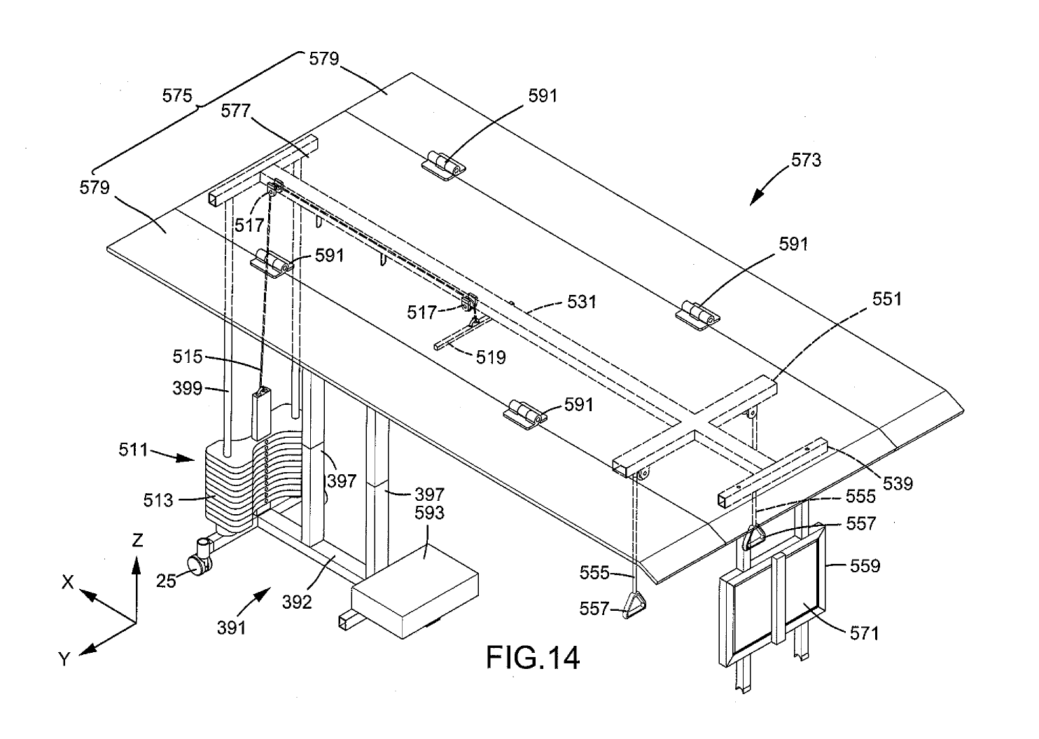

FIG. 15 is a side elevational view of the rehabilitation bed with a table attached to the rehabilitation bed.

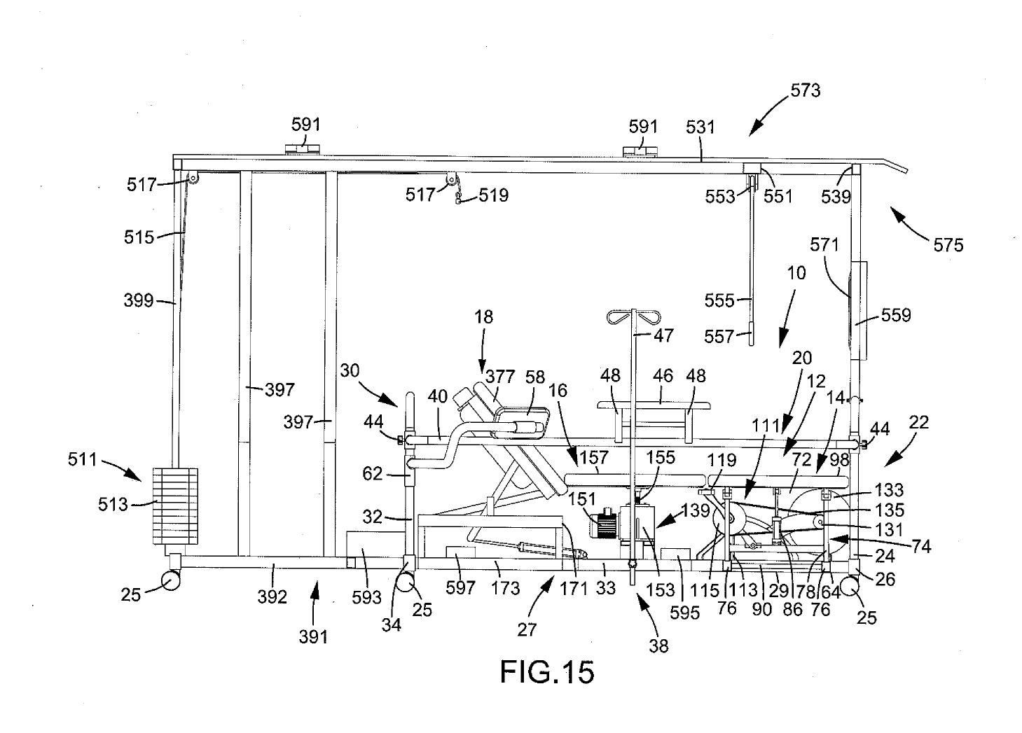

FIG. 16 is a view similar to FIG. 7, with the middle section of the mattress unit moved from a lower position to an upper position.

FIG. 17 is a partial, exploded, perspective view of the rehabilitation bed of FIG. 1, with two wings of a solar panel of the solar energy storage device folded.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “lower”, “upper”, “top”, “bottom”, “side”, “end”, “portion”, “section”, “horizontal”, “vertical”, “transverse”, “spacing”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

A rehabilitation bed according to the present invention is shown in the drawings and generally designated 10. According to the form shown, the rehabilitation bed 10 includes a frame assembly 20 including a first fence 22, a second fence 30 spaced from the first fence 22 along a first axis X, and a chassis 27 extending between the first and second fences 22 and 30. The first fence 22 includes two vertical posts 24 spaced from each other along a second axis Y perpendicular to the first axis X. Provided between the vertical posts 24 are a horizontal rod 26 and a rail 28 spaced from the horizontal rod 26 along a third axis Z perpendicular to the first and second axes X and Y. The second fence 30 includes two vertical posts 32 spaced from each other along the second axis Y. Provided between the vertical posts 32 are a horizontal rod 34 and a rail 36 spaced from the horizontal rod 34 along the third axis Z. The chassis 27 includes a first portion 29 adjacent to the first fence 22, a second portion 31 adjacent to the second fence 30, and an intermediate portion 33 between the first and second portions 29 and 31. The first portion 29 of the chassis 27 is fixed to the horizontal rod 26 of the first fence 22. The second portion 31 is fixed to the horizontal rod 34 of the second fence 30. Two protective bars 40 are mounted between the first and second fences 22 and 30 and are spaced from each other along the second axis Y. Each protective bar 40 includes two positioning sleeves 42 spaced from each other along the first axis X. The two positioning sleeves 42 are respectively mounted around one of the vertical posts 24 of the first fence 22 and one of the vertical posts 32 of the second fence 30 and are fixed by screws 44. Two casters 25 are mounted to distal ends of each of the horizontal rods 26 and 34.

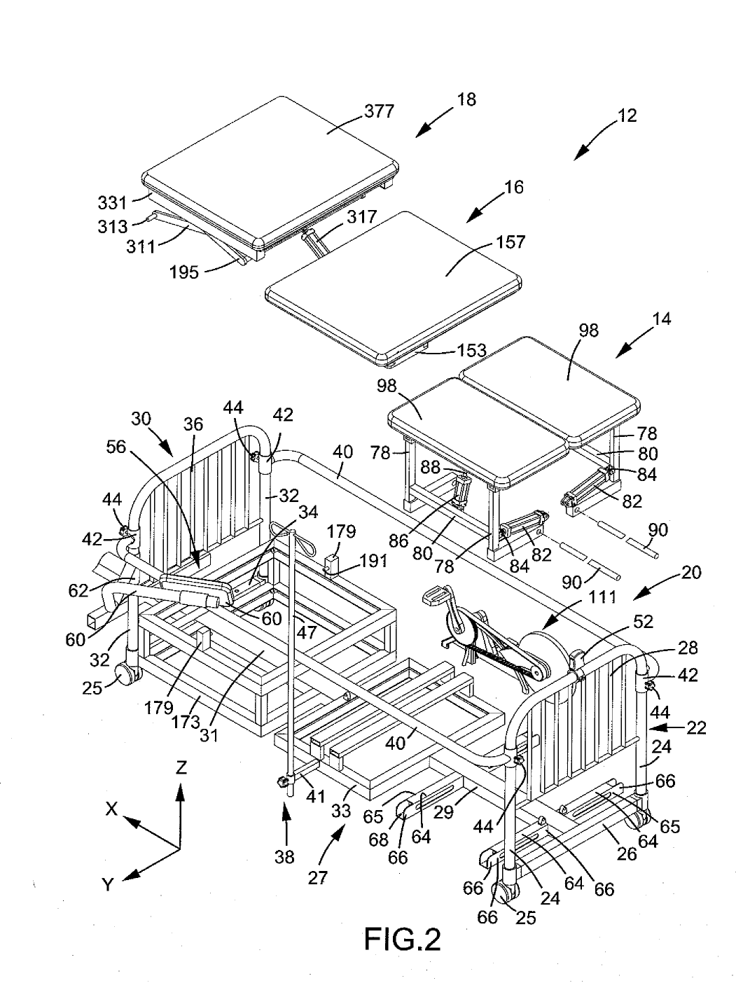

According to the form shown, the rehabilitation bed 10 further includes a mattress unit 12 mounted to the chassis 27. The mattress unit 12 includes a mattress leg section 14 (FIG.2) mounted to the first portion 29. The mattress leg section 14 includes two tracks 64 mounted to two sides of the first portion 29. Each track 64 includes two tubes spaced from each other along the first axis X. Each tube includes two sides 65 spaced from each other along the first axis X and first and second ends 66 spaced from each other along the second axis Y, with the first end 66 fixed to the first portion 29. Each track 64 further includes a sliding channel 68 extending from the second end 66 towards the first end 66 of the track 64 along the second axis Y. Each side 65 includes a guiding slot 70 in communication with the sliding channel 68.

The mattress leg section 14 further includes two sliding seats 74 slideably coupled to the sliding tracks 64. Each sliding seat 74 includes two transverse beams 76. A vertical beam 78 extends upright from an end of each transverse beam 76. A connecting beam 80 extends between the vertical beams 78. Each transverse beam 76 of each sliding seat 74 is slideably received in one of the sliding channels 68 of one of the tracks 64. The sliding seats 74 are located on two sides of the first portion 29. Two rods 90 are provided, with each rod 90 extending through the guiding slots 70 of one of the tracks 64 and the transverse beams 76 of one of the sliding seats 74.

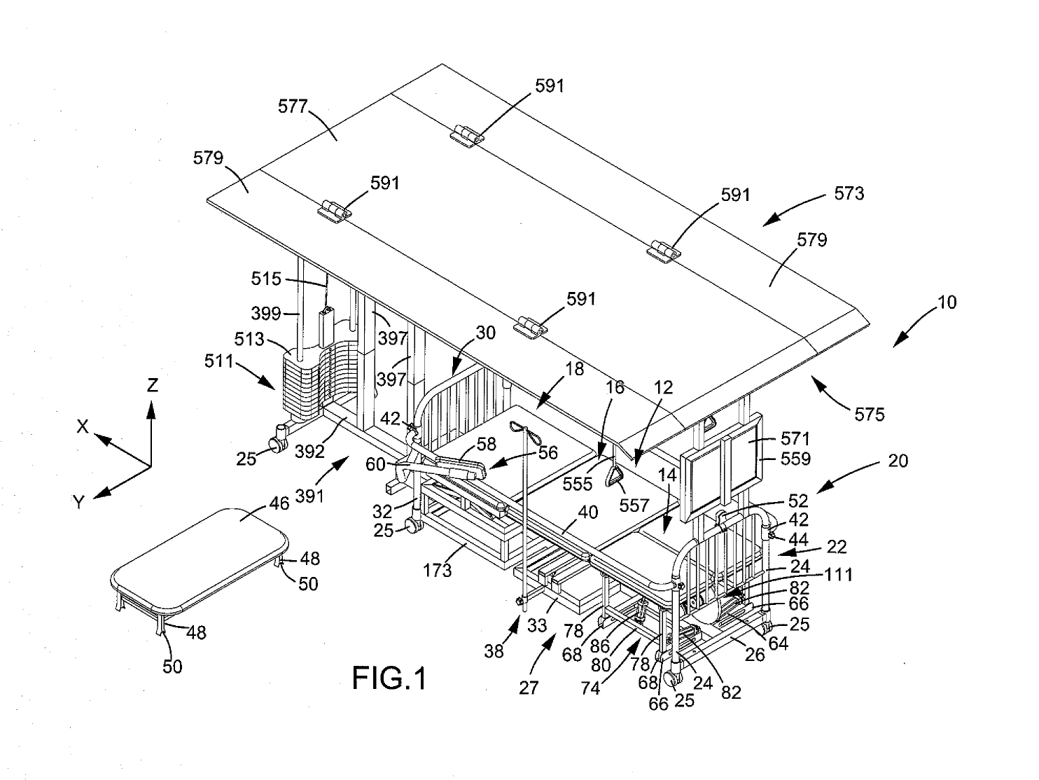

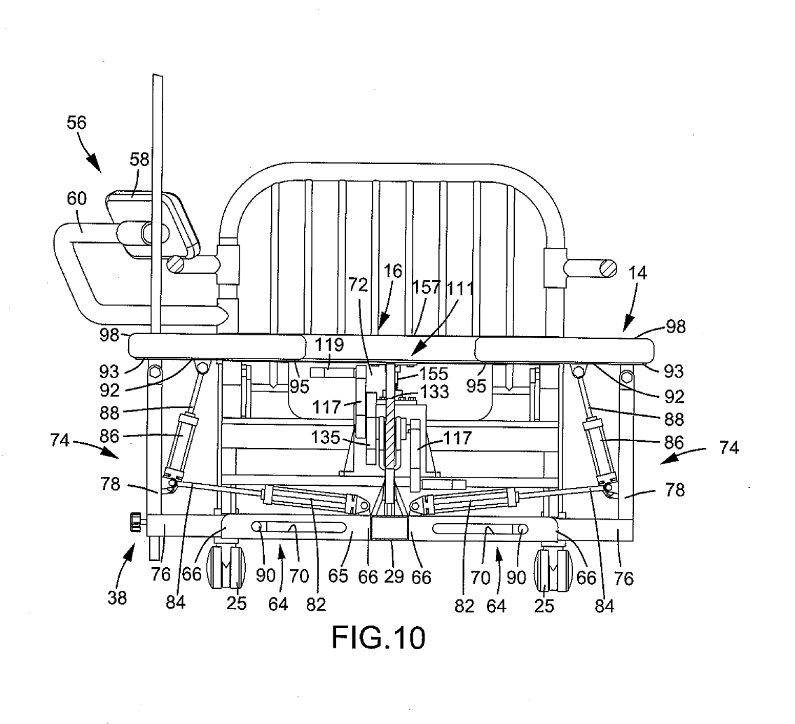

The mattress leg section 14 further includes two bottom boards 92 and two legrests 98 respectively fixed to the bottom boards 92. Each bottom board 92 includes first and second sides 93 and 95 spaced from each other along the second axis Y. Two first pivotal blocks 94 are formed on a bottom side of each bottom board 92 and are located adjacent to the first side 93. Furthermore, a second pivotal block 96 is formed on an intermediate portion of the bottom side of each bottom board 92 and is located between the two first pivotal blocks 94. Each first pivotal block 94 of each bottom board 92 is pivotably connected to one of the vertical beams 78 of one of the sliding seats 74. Thus, each bottom board 92 is pivotable between a horizontal position (FIGS. 1, 8, and 9) and a tilted position (FIG. 10) about a first pivot axis defined by the first pivotal blocks 94 and parallel to the first axis X.

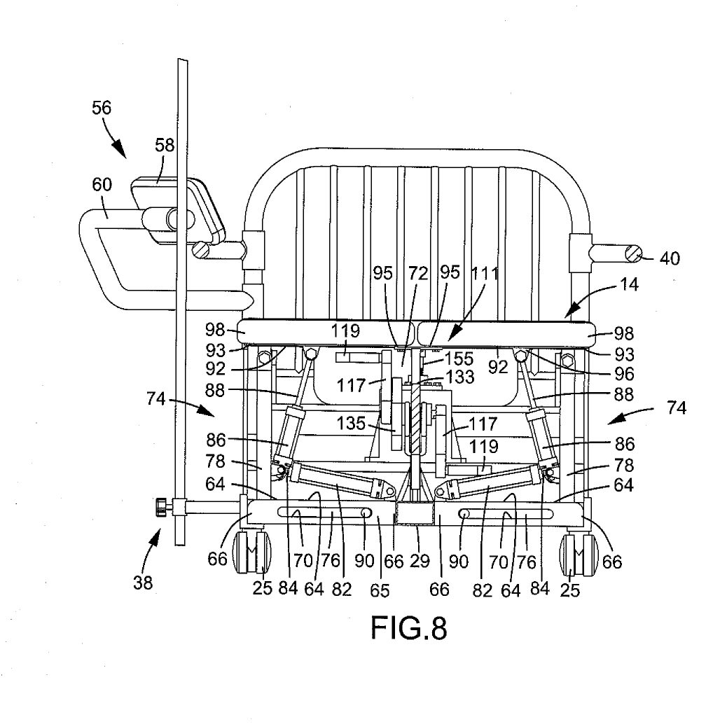

According to the form shown, the mattress leg section 14 further includes two first cylinders 82 and two second cylinders 86. Each of the first and second cylinders 82 and 86 can be a hydraulic or pneumatic cylinder. Each first cylinder 82 includes a telescopic piston rod 84. An end of each first cylinder 82 is pivotably connected to one of the tracks 64. A distal end of each piston rod 84 is pivotably connected to one of the sliding seats 74. Each second cylinder 86 includes a telescopic piston rod 88. A distal end of each piston rod 84 is pivotably connected to the second pivotal block 96 of one of the bottom boards 92 on a corresponding legrest 98. A first power supply 595 is mounted to the chassis 27 to provide power to each first cylinder 82 and each second cylinder 86. Each first cylinder 82 pushes a corresponding sliding seat 74 to slide along the sliding channel 68 of a corresponding track 64 along a closed position (FIGS. 1 and 8, the legrests 98 are parallel and close to each other) and an open position (FIG. 10, the legrests 98 are spaced from each other). Note that the sliding seats 74 in the first position are close to each other and are located adjacent to the first portion 29 of the chassis 27, and the two sliding seats 74 in the second position are spaced from each other and have a spacing therebetween larger than a spacing between the sliding seats 74 in the first position. Each second cylinder 86 controls a corresponding bottom board 92 to pivot between the horizontal position and the tilted position about the pivot axis defined by the corresponding first pivotal blocks 94.

The rehabilitation bed 10 further includes a pedaling portion 111 mounted to the first portion 29 of the chassis 27. The pedaling portion 111 includes an upright support 113 and a driving wheel 115 rotatably mounted to the upright support 113. Two crank arms 117 are mounted to two sides of the driving wheel 115. A pedal 119 is mounted to each crank arm 117. The pedaling portion 111 further includes a driven wheel 131 rotatably mounted to the upright support 113. A flywheel 133 is fixed to the driven wheel 131 to rotate therewith. A belt 135 is mounted around the driving wheel 115 and the driven wheel 131. The upright support 113 is fixed to the first portion 29 of the chassis 27. Thus, the pedaling portion 111 is located in a receiving space 72 defined by the two sliding seats 74, the two legrests 98, and the first portion 29 of the chassis 27.

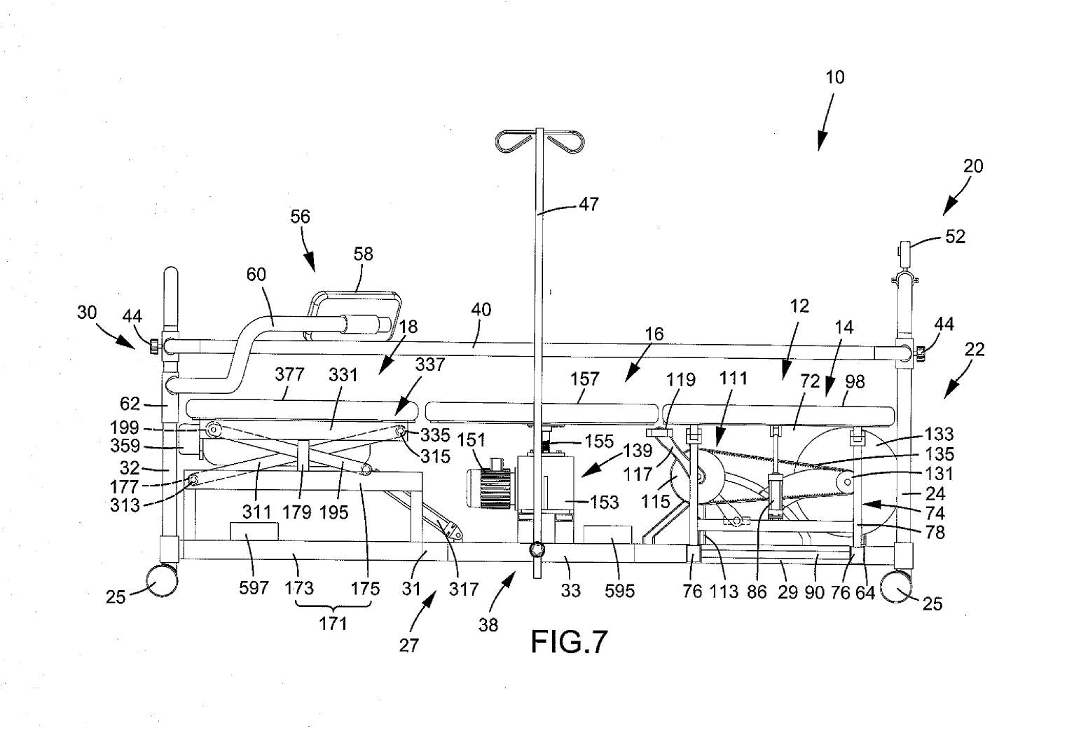

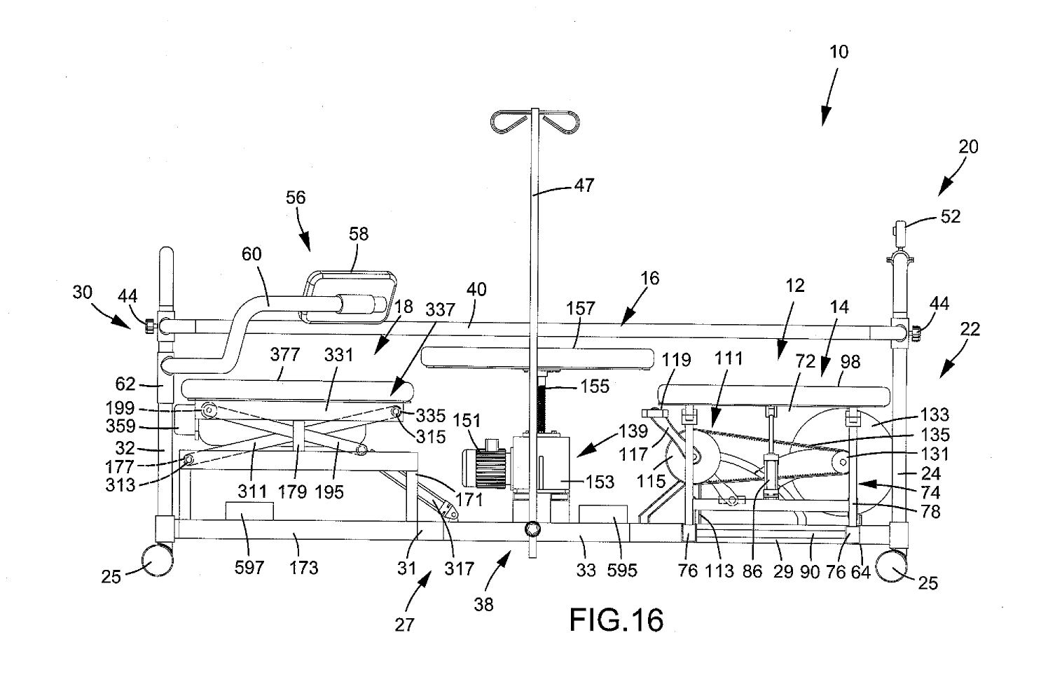

According to the form shown, the mattress unit 12 further includes a mattress middle section 16 mounted to the intermediate portion 33 of the chassis 27. The mattress middle section 16 includes a gear reduction mechanism 153 mounted to the intermediate portion 33 of the chassis 27. A motor 151 includes a rotating shaft coupled to the gear reduction mechanism 153. A screw 155 extends along the third axis Z and meshes with the gear reduction mechanism 153. The mattress middle section 16 includes a middle mat 157 fixed to a distal end of the screw 155. When the motor 151 operates, the screw 155 moves along the third axis Z to move the middle mat 157 between an upper position (FIG. 16, the middle mat 157 is not aligned with the legrests 98) and a lower position (FIG. 7, the middle mat 157 is aligned with the legrests 98).

According to the form shown, the mattress unit 12 further includes a mattress back section 18 mounted to the second portion 31 of the chassis 27. The mattress back section 18 includes a fixing seat 171 including a first frame 173 fixed to the second portion 31 and a second frame 175 mounted above the first frame 173 and spaced from the first frame 173 along the third axis Z. The second frame 175 includes two pivotal blocks 179 spaced from each other along the second axis Y. Two axles 191 are provided on two mutually facing sides respectively of the two pivotal blocks 179. An end of the second frame 175 includes two first pivotal ears 177 spaced from each other along the second axis Y.

According to the form shown, the mattress back section 18 further includes a tilt device 193 fixed to the fixing sat 171 and a massage device 337 coupled to the tilt device 193 to move therewith. The massage device 337 includes a seat 351 having an installation space 353. A motor 359 is fixed to the seat 351. A screw rod 357 extends along the first axis X and is rotatably mounted in the installation space 353. An end of the screw rod 357 is coupled to an output end of the motor 359. The massage device 337 further includes a movable block 371 threadedly coupled to the screw rod 357. A plurality of massaging wheels 375 is rotatably mounted to the movable block 371. A back mat 377 is fixed to a side of the seat 351. Each massage wheel 375 abuts an inner side of the back mat 377. When the motor 359 drives the screw rod 357 to rotate in a clockwise or counterclockwise direction, the screw rod 357 moves the movable block 371 to move in the installation space 353.

The tilt device 193 includes two first rods 195 parallel to each other, two second rods 311 parallel to each other, two track rods 331, and a third cylinder 317. A fixing rod 197 extends between an end of one of the two first rods 195 and an end of the other first rods 195. A roller 199 is rotatably mounted to the other end of each first rod 195. An intermediate portion of each first rod 195 is pivotably connected to the axle 191 of one of the pivotal blocks 179. Thus, each first rod 195 is pivotable about a pivot axis defined by the corresponding axle 191.

A first pin 313 is mounted to an end of each second rod 311. A second pin 315 is mounted to the other end of each second rod 311. An intermediate portion of each second rod 311 is pivotably connected to the axle 191 of one of the pivotal blocks 179. Furthermore, each first pin 313 is pivotably connected to one of the first pivotal ears 177 of the second frame 175. Thus, an inclination angle of each second rod 311 relative to the second frame 175 is fixed. Namely, each second rod 311 cannot be moved. Note that each second rod 311 is cross-hinged to one of the first rods 195.

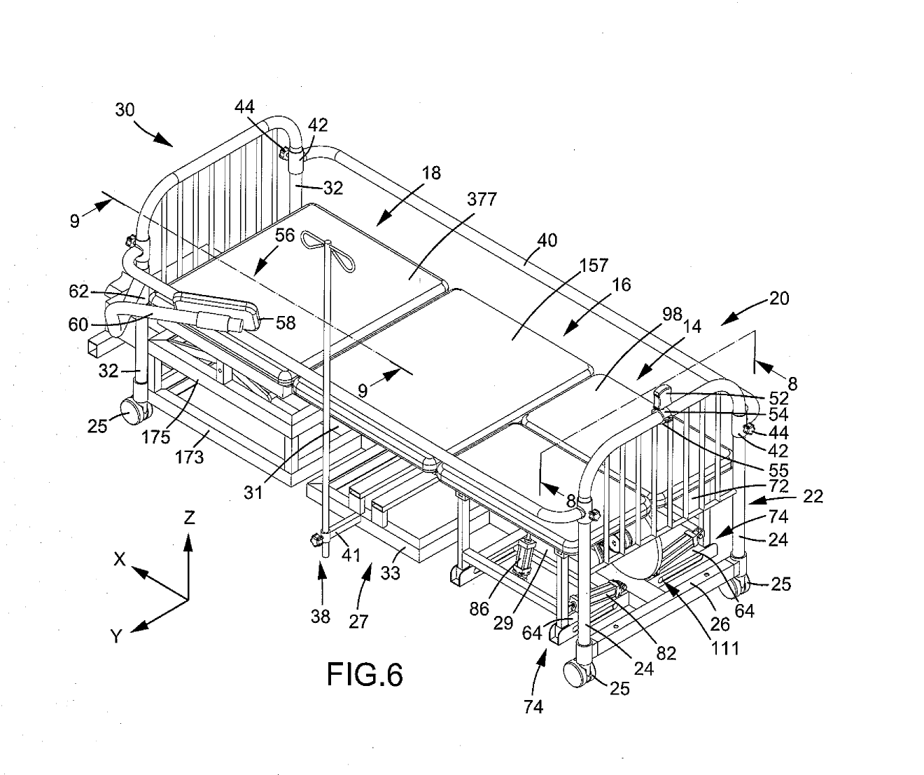

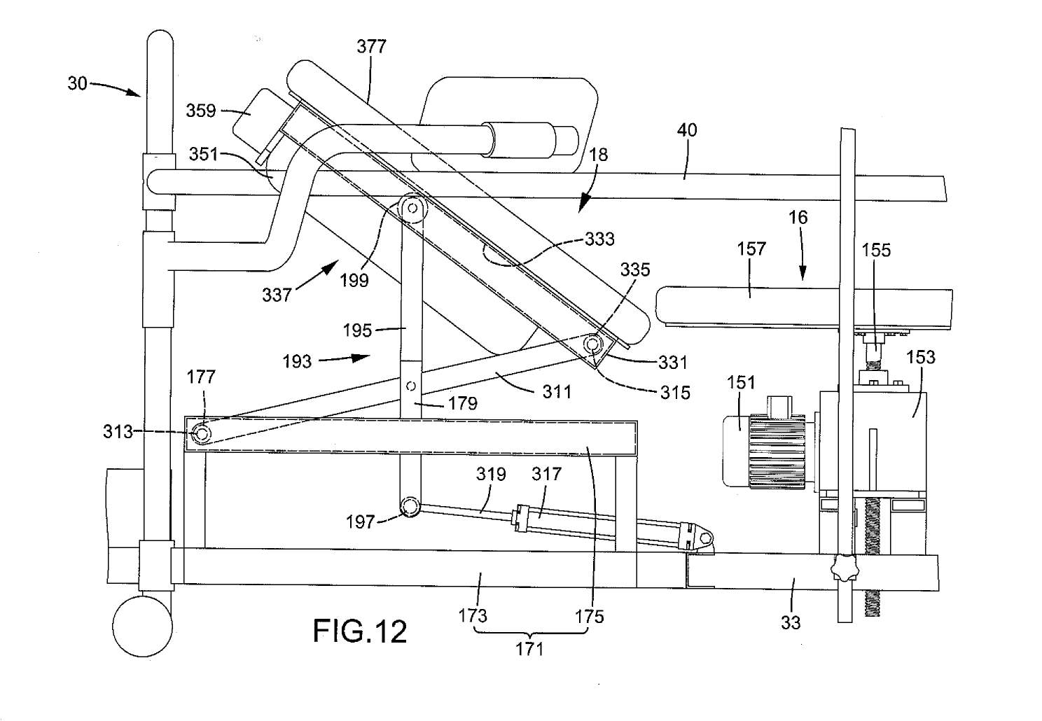

The track rods 331 are fixed to a bottom of the seat 351 of the massage device 337 and are spaced from each other along the second axis Y. Two sliding grooves 333 are respectively defined in two mutually facing sides respectively of the track rods 331. A second pivotal ear 335 is provided on an end of each sliding groove 333 distant to the corresponding first pivotal ear 177. The second pin 315 of each second rod 311 is pivotably connected to the second pivotal ear 335 of one of the track rods 331. The roller 199 on each first rod 195 is received in the sliding groove 333 of one of the track rods 331. Thus, when each first rod 195 pivots, each roller 199 slides in the sliding groove 333 of a corresponding track rod 331. Furthermore, each roller 199 pushes the corresponding track rod 331 to pivot about a second pivot axis defined by the second pin 315 of the corresponding second rod 311. Thus, the back mat 377 and the massage device 337 are moved between a first position parallel to the middle mat 157 (FIGS. 6, 7, and 9) and a second position at an obtuse angle to the middle mat 157 (FIG. 12). Note that when the massage device 337 is not in the first position, the back mat 377 is at an obtuse angle to the middle mat 157.

The third cylinder 317 can be a hydraulic or pneumatic cylinder. The third cylinder 317 includes a telescopic piston rod 319. An end of the third cylinder 317 is pivotably connected to the second portion 31 of the chassis 27. The other end of the third cylinder 317 is pivotably connected to the fixing rod 197. The third cylinder 317 pushes each first rod 195 to pivot about the corresponding pivot axis defined by the corresponding first rod 195 via transmission by the fixing rod 197.

According to the form shown, the mattress back section 18 further includes a second power supply 597 mounted to the second portion 31 of the chassis 27. The second power supply 597 provides power to the third cylinder 317.

According to the form shown, the rehabilitation bed 10 further includes a monitor 52 mounted to the first fence 22 and a drip stand 38. The monitor 52 is used to monitor the patient lying in the rehabilitation bed 10. The drip stand 38 is mounted to a fixing rod 41 fixed to the intermediate portion 33 of the chassis 27. The drip stand 38 includes a post 47 detachably mounted to the fixing rod 41. An intravenous injection bag is adapted to be hung on the post 47.

According to the form shown, the rehabilitation bed 10 further includes a table 46 movably mounted to the two protective bars 40. Two table legs 48 are provided to each of two sides of a bottom face of the table 46. A recessed crossing section 50 is formed in a bottom end of each table leg 48. The recessed crossing section 50 of the table legs 48 rest on the two protective bars 40, permitting the table 46 to be detachably mounted to the protective bars 40 (FIG. 1). The table 46 is mounted on the two protective bars 40 when in use. The table 46 is removed from the two protective bards 40 when not in use.

According to the form shown, the rehabilitation bed 10 further includes an auxiliary exerciser 511 mounted to the chassis 27. The auxiliary exerciser 511 includes an outer support 391 having a lower beam 392 connected to the horizontal rod 34 of the second fence 30 and an upper beam 531 spaced from the lower beam 392 along the third axis Z. The upper beam 531 is located above the mattress unit 12 along the third axis Z. The outer support 391 further includes two support rods 397 extending between the upper and lower beams 531 and 392. Two casters 25 are rotatably mounted to a bottom of the lower beam 392. The outer support 391 further includes two guiding rods 399 extending between the upper and lower beams 531 and 392. The upper beam 531 includes first and second upper transverse beams 539 and 551 on an end thereof distant to the guiding rods 399. A plurality of weight blocks 513 is movably mounted along the guiding rods 399. Two first pulleys 517 are mounted on the upper beam 531 and are spaced from each other along the first axis X. A cable 515 is wound around the two first pulleys 517 and includes an end coupled to a handle 519. The other end of the cable 515 is connected to at least one weight block 513. Two second pulleys 553 are provided on the second upper transverse beam 551 and are spaced from each other along the second axis Y. A pull cord 555 is wound around the two second pulleys 553. A pull ring 557 is mounted to each of two ends of the pull cord 555. A support 559 extends along the third axis Z and is fixed between the first upper transverse beam 539 and the first fence 22. A display 571 is mounted to the support 559.

According to the form shown, the rehabilitation bed 10 further includes a controller 56 pivotably mounted to the second fence 30. The controller 56 includes an arm 60 pivotably connected to one of the vertical posts 32 and an operation box 58 mounted to a distal end of the arm 60. The operation box 58 of the controller 56 is electrically connected to the first and second power supplies 595 and 597, the motors 151 and 359, and the monitor 52. Thus, various functions of the rehabilitation bed 10 can be controlled via operation of the operation box 58. Furthermore, the operation box 58 can include a satellite positioning device.

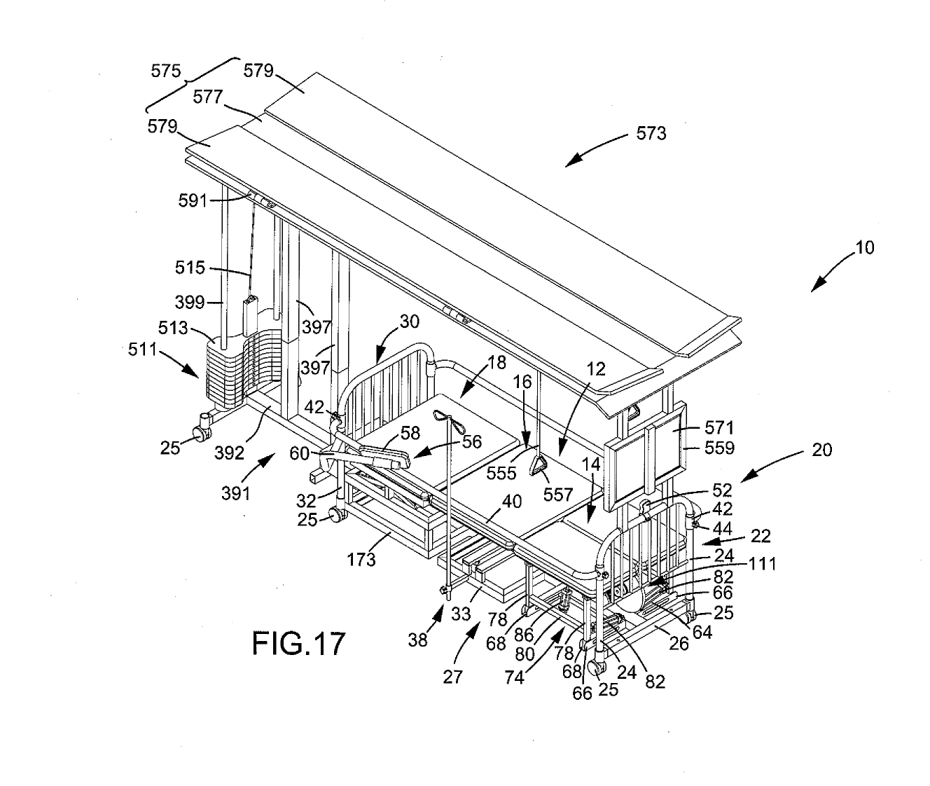

According to the form shown, the rehabilitation bed 10 further includes a solar energy storage device 573. The solar energy storage device 573 includes a solar panel 575 and a cell 593 electrically connected to the solar panel 575. The solar panel 575 includes a main board 577 fixed to the upper beam 531 of the outer support 391 and two wings 579 pivotably mounted to two sides of the main board 577 by hinges 591. Thus, each wing 579 can be pivoted about a pivot axis defined by the hinges 591 between a folding position folded to the main board 577 (FIG. 17) and an extended position flush with the main board 577 (FIG. 1). The cell 593 is fixed to the lower beam 392 of the outer support 391. The cell 593 is electrically connected to the operation box 58 of the controller 56, the display 571, the monitor 52, the motors 151 and 359, and the first and second power supplies 595 and 597.

Now that the basic construction of the rehabilitation bed 10 has been explained, the operation and some of the advantages of the rehabilitation bed 10 can be set forth and appreciated. In particular, for the sake of explanation, it will be assumed that each sliding seat 74 of the mattress leg section 14 is in the closed position such that the legrests 98 are close to each other. Furthermore, the legrests 98 are in the horizontal state and are received in the receiving space 72. Thus, the pedaling portion 111 is not exposed (see FIGS. 1, 6, and 8). The middle mat 157 of the mattress middle section 16 is in the lower position flush with the legrests 98, and the back mat 377 of the mattress back section 18 is in a horizontal position flush with the middle mat 157. In this case, the legrests 98, the middle mat 157, and the back mat 377 are at the same height along the third axis Z and are parallel to each other to permit the patient to lie on them for rest.

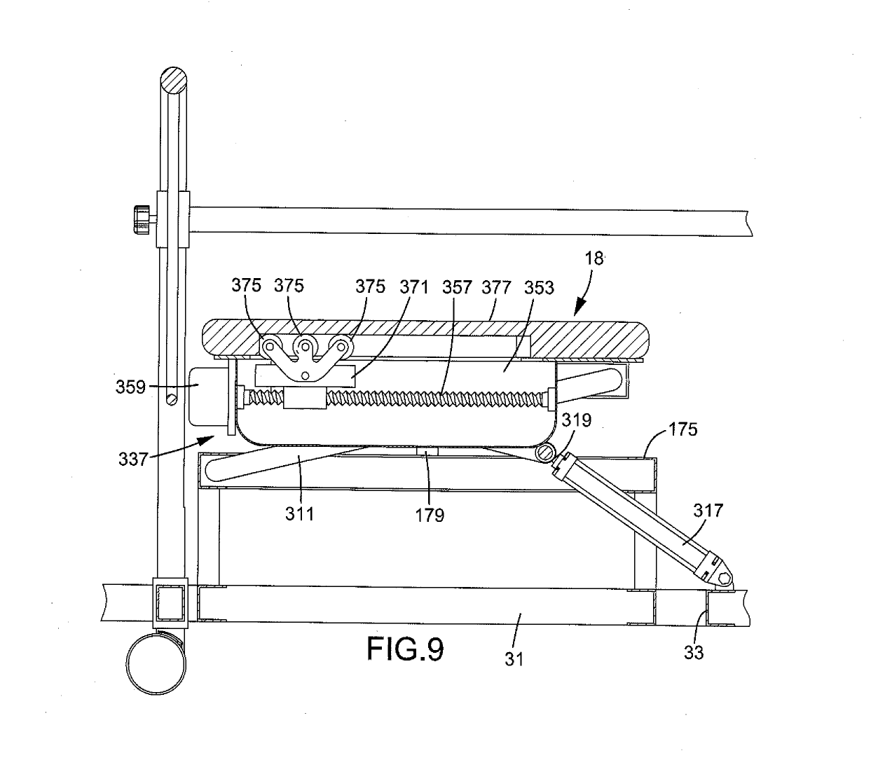

In a case that the upper body of the patient needs to be supported (such as for eating), by operating the operation box 58 to extend the piston rod 319 of the mattress back section 18, the two first rods 195 pivot to actuate the track rods 331, which, in turn, push the massage device 337 and the back mat 377 to pivot from the horizontal position (FIGS. 7 and 9) to the tilted position (FIG. 12) about the second pivot axis defined by each second pin 315. Thus, the upper body and the head of the patient can be supported by the back mat 377. Thus, the patient can be in a sitting position on the mattress unit 12, and the food can be placed on the table 46 extending across the protective bards 40, permitting the patient to eat in the rehabilitation bed 10. Furthermore, when the patient in the sitting position can pull the handles 519 to move at least one weight block 513. Thus, the patient can proceed with weight training of the arms on the bed.

Furthermore, when the back mat 377 is in the first position, each sliding seat 74 is in the closed position, and the legrests 98 are in the horizontal position, the operation box 58 can be operated to move the middle mat 157 from the lower position to the upper position. Thus, the body of the patient will be held in a state in which the arms and legs are in the air, permitting the patient to proceed with rehabilitation of the arms and legs.

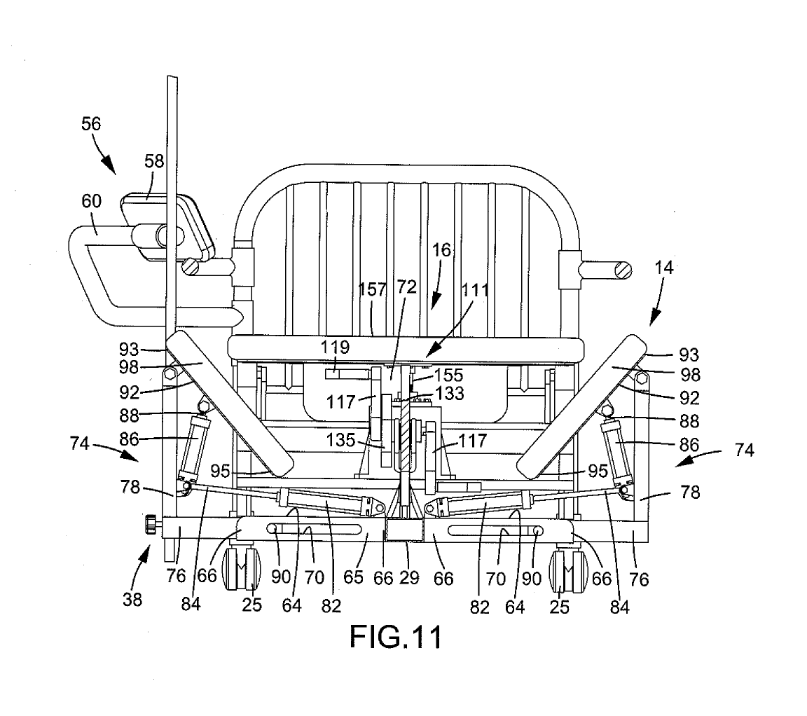

Furthermore, the rehabilitation bed 10 provides an exercising effect similar to a bicycle. Specifically, when the back mat 377 is in the first position and the middle mat 157 is in the lower position, the operation box 58 can be operated to move each sliding seat 74 from the closed position (FIG. 8) to the open position (FIG. 10). After each sliding seat 74 reaches the open position, the legrests 98 are controlled to pivot from the horizontal position (FIG. 10) to the tilted position (FIG. 11) about the first pivot axis, causing opening of the receiving space 72 to reveal the pedaling portion 111. Thus, the feet of the patient can extend into the receiving space 72 and rest on the pedals 119 to pedal the flywheel 133 to rotate, achieving exercising and rehabilitation effect of the feet.

When the back mat 377 is in the first position, each sliding seat 74 is in the closed position, the legrests 98 are in the horizontal position, and the middle mat 157 is in the lower position, the patient lying on the mattress unit 12 can pull the pull rings 557 to lift the feet up into the air. Thus, the pull cord 555 and the push rings 557 can be used to exercise the legs. Furthermore, the patient can hold the pull rings 557 to keep the hands in the air. Thus, the pull rings 557 and the pull cord 555 can be used to aid the patient to lift the arms. Furthermore, the display 571 can play films demonstrating movement of a corresponding one of various rehabilitation movements, permitting the patient to learn the movements from the films.

The rehabilitation bed 10 can be used with an ordinary power socket. In this case, the solar energy function is not required, and the wings 579 can be folded to the main board 577 of the solar panel 575 (FIG. 17). If use of solar energy is required, the wings 479 are unfolded to be flush with the main board 577 (FIG. 1) such that the solar energy can be converted into electricity and stored in the cell 593 for use by the rehabilitation bed 10.

The rehabilitation bed 10 allows various types of rehabilitation functions such that the patient can proceed with rehabilitation at any time without getting out of the bed. Furthermore, the controlling functions of the rehabilitation bed 10 are integrated in the operation box 58 to permit easy control by the patient, providing high utility.

Furthermore, the rehabilitation bed 10 can convert the solar energy into electricity for use by the rehabilitation bed 10, which is eco-friendly.

Furthermore, the monitor 52 of the rehabilitation bed 10 permits real-time monitoring of the patient. As an example, operation of the patient using the rehabilitation bed 10 for rehabilitation can be monitored. Furthermore, the monitor 52 can show rehabilitation films to the patient such that the patient can watch the films and learn exact rehabilitation movements while proceeding with rehabilitation.

The massage device 337 on the mattress back section 18 of the rehabilitation bed 10 can massage the body of the patient in the area of the back mat 377, relieving the body of the patient.

Now that the basic teachings of the present invention have been explained, many extensions and variations will be obvious to one having ordinary skill in the art. For example, the rehabilitation bed 10 does not have to include the solar energy storage device 573 and can be connected by a plug to a power socket to receive the desired electricity. Furthermore, each sliding track 64 can include only one sliding channel 68, and each sliding seat 74 can include only one transverse beam 76 and only one vertical beam 78 and does not have to include the connecting beam 80. Furthermore, each bottom board 92 can include only one first pivotable block 94. Furthermore, the massage device 337 can directly be pivotably connected to the second portion 31 of the chassis 27, and the piston rod 319 of the third cylinder 317 can be pivotably connected to the seat 351 of massage device 337. In this case, when the piston rod 319 of the third cylinder 317 moves, the massage device 337 and the back mat 377 are jointly pivoted between the first and second positions. Furthermore, the mattress back section 18 does not have to include the massage device 337 without adversely affecting the other functions of the rehabilitation bed 10.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A rehabilitation bed comprising:
a frame assembly including a first fence, a second fence spaced from the first fence along a first axis, and a chassis extending between the first and second fences, with the chassis including a first portion adjacent to the first fence, a second portion adjacent to the second fence, and an intermediate portion between the first and second portions;
two tracks respectively mounted to two sides of the first portion of the chassis, with each of the two tracks including first and second ends spaced from each other along a second axis perpendicular to the first axis and a sliding channel extending from the second end towards the first end of the track;
two sliding seats respectively and slideably coupled to the two sliding tracks, with each of the two sliding seats including a transverse beam slideably received in the sliding channel of one of the two sliding tracks, with each of the two sliding seats further including a vertical beam extending from the transverse beam and located outside of the sliding channel;
two bottom boards respectively mounted to the vertical beams of the two sliding seats;
two legrests respectively fixed to the two bottom boards;
two first cylinders, with each of the two first cylinders including a telescopic piston rod coupled to the one of the two sliding seats, with each of the two first cylinders including an end connected to one of the two tracks, with each of the two first cylinders operable to push one of the two sliding seats to move between a closed position and a second position, wherein the two sliding seats in the first position are close to each other and are located adjacent to the first portion of the chassis, and wherein the two sliding seats in the second position are spaced from each other and have a spacing therebetween larger than a spacing between the two sliding seats in the first position;
a first power supply fixed to the chassis and connected to each of the two first cylinders to provide power to the two first cylinders;
a pedaling portion mounted to the first portion of the frame assembly and located between the two sliding seats and the two bottom boards, with the pedaling portion including an upright support fixed to the first portion of the frame assembly and a flywheel rotatably mounted to the upright support, with two pedals rotatably mounted to the upright support and located on two sides of the upright support, with the two pedals operably connected to the flywheel;
a mattress middle section mounted to the intermediate portion of the chassis, with the mattress middle section including a middle mat;
a mattress back section mounted to the second portion of the chassis, with the mattress back section including a back mat,
wherein when the two sliding seats are in the closed position, the two legrests are close to each other to cover the pedaling portion, not permitting use of the pedaling portion, and
wherein when the two sliding seats are in the open position, the two legrests are spaced from each other to reveal the pedaling portion, permitting use of the pedaling portion.

2. The rehabilitation bed as claimed in claim 1, with each of the two bottom boards including first and second sides spaced from each other along the second axis, with a first pivotal block mounted to a bottom side of each of the two bottom boards and located adjacent to the first side of the bottom board, with the first pivotal block defining a first pivot axis parallel to the first axis, with a second pivotal block mounted to an intermediate portion of the bottom side of each of the two bottom boards, with the first pivotal block on each of the two bottom boards pivotably mounted to the vertical beam, with the rehabilitation bed further comprising:
two second cylinders connected to the first power supply, with each of the two second cylinders connected to one of the two sliding seats and including a telescopic piston rod having an end pivotably connected to the second pivotal block of one of the two bottom boards, with each of the two second cylinders operable to control one of the two bottom boards to pivot between a horizontal position and a tilted position about the first pivot axis defined by the first pivotal block,
wherein when the two sliding seats are in the closed position, the two legrests are in the horizontal position, and
wherein when the two sliding seats are in the open position, each of the two second cylinders are operable to control one of the two legrests to pivot to the tilted position.

3. The rehabilitation bed as claimed in claim 1, with the mattress back section including:
a massage device pivotably mounted to the second portion of the chassis, with the back mat mounted to a side of the massage device;
a third cylinder including a telescopic piston rod connected to the massage device, with the telescopic piston rod including an end pivotably connected to the chassis, with the third cylinder operable to push the massage device to pivot between a first position and a second position about a second pivot axis parallel to the second axis; and
a second power supply fixed to the chassis and connected to the third cylinder to provide power to the third cylinder,
wherein when the massage device is in the first position, the back mat is parallel to the middle mat, and
wherein when the massage device is not in the first position, the back mat is at an obtuse angle to the middle mat.

4. The rehabilitation bed as claimed in claim 3, with the mattress back section further including:
a fixing seat fixed to the second portion of the chassis, with the fixing seat including two first pivotal ears spaced from each other along the second axis and defining the second pivot axis;
two pivotal blocks mounted to the fixing seat and spaced from each other along the second axis;
two track rods fixed to a bottom side of the massage device, with two sliding grooves defined in two mutually facing sides respectively of the two track rods;
two first rods, with each of the two first rods including an end slideably received in one of the two sliding grooves, with each of the two first rods including an intermediate portion pivotably connected to one of the two pivotal blocks;
a fixing rod fixed to another end of each of the two first rods, with the fixing rod pivotably connected to a distal end of the telescopic piston rod of the third cylinder;
two second rods, with each of the two second rods including an intermediate portion pivotably connected to one of the two pivotal blocks, with each of the two second rods including an end pivotably connected to one of the two track rods, with each of the two second rods cross-hinged to one of the two first rods, with each of the two second rods further including another end pivotably connected to one of the first pivotal ears, fixing an inclination angle of each of the two second rods.

5. The rehabilitation bed as claimed in claim 4, with the massage device including:
a seat fixed to the two track rods, with the seat including an installation space defined in a side thereof;
a first motor mounted to the seat;
a screw rod rotatably mounted in the installation space of the seat and extending along the first axis, with the screw rod including an end coupled to the motor;
a movable block threadedly coupled to the screw rod, wherein the motor is operable to rotate the screw rod, moving the movable block in the installation space; and
a plurality of massaging wheels mounted to the movable block and abutting the back mat.

6. The rehabilitation bed as claimed in claim 5, with the mattress middle section further including:
a gear reduction mechanism mounted to the intermediate portion of the chassis;
a second motor including a rotating shaft coupled to the gear reduction mechanism;
a screw coupled to the gear reduction mechanism and extending along the third axis, with the middle mat fixed to the screw, with the second motor operable to move the screw along the third axis, moving the middle mat between an upper position not aligned with and higher than the two legrests along the third axis and a lower position aligned with the two legrests.

7. The rehabilitation bed as claimed in claim 1, further comprising:
an outer support fixed to the frame assembly, with the outer support including an upper beam above the frame assembly and a lower beam fixed to the second fence and located below the back mat;
two guiding rods fixed to the lower beam and spaced from each other along the second axis;
a plurality of weight blocks slideably mounted around the two guiding rods;
two first pulleys rotatably mounted to the upper beam;
a cable including a first end coupled to the plurality of weight blocks and a second end wound around the two first pulleys;
a handle coupled to the second end of the cable; and
a support fixed between the upper beam and the first fence,
wherein if the handle is pulled, the plurality of weight blocks is moved along the two guiding rods.

8. The rehabilitation bed as claimed in claim 7, further comprising:
a solar panel fixed to the upper beam; and
a cell mounted to the lower beam and electrically connected to the solar panel.

9. The rehabilitation bed as claimed in claim 6, further comprising:
two protective bars spaced from each other along the second axis and mounted between the first and second fences;
a table detachably mounted to the two protective bars;
a monitor mounted to the first fence;
an arm pivotably mounted to the second fence; and
a controller mounted to the arm and electrically connected to the massage device, the first and second power supplies, and the first and second motors.
